(19) United States
(12) Patent Application Publication
(10) Pub. No.: US 2015/0310357 A1
(43) Pub. Date: Oct. 29, 2015

(54) Handling Process Instance Migration In Business Process Management

(71) Applicant: INTERNATIONAL BUSINESS MACHINES CORPORATION, Armonk, NY (US)

(72) Inventors: Thomas Baudel, Paris (FR); Nicolas Sauterey, Fresnes (FR); Claudia Zentner, Stuttgart (DE)

(21) Appl. No.: 14/647,862

(22) PCT Filed: Dec. 4, 2013
(86) PCT No.: PCT/IB2013/060623

§ 371 Date: May 28, 2015

(30) Foreign Application Priority Data
Jan. 8, 2013 (GB) 1300256.3

(51) Int. Cl. G06Q 10/06

(52) U.S. Cl. CPC G06Q 10/067; G06Q 10/0637

(57) ABSTRACT

Process instance migration from a former process model to a new process model. A former process model and a new process model and their data models are analyzed to extract a process delta object model relating to changes in the new process model on which to define migration rules. One or more existing process instances are analyzed, and process instances whose current state has passed the changes in the new process model are retained. Candidate activities of the retained process instances, a set of conditions for the candidate activities, and a set of actions to be taken if a condition is met are generated. The generated set of conditions and set of actions may be presented to a user enabling the user to combine conditions and actions to produce a process instance migration program in the form of a set of rules.

### FIELD OF THE INVENTION

This invention relates to the field of business process management. In particular, the invention relates to handling process instance migration in business process management.

### BACKGROUND

The domain of business process management provides technologies aimed at modeling, implementing, executing and evolving enterprise business processes. Those business processes involve numerous people, resources, activities and decisions, which must be defined, made visible, orchestrated and monitored. Claims processing in an insurance company is a typical example of a complex business process that requires a complete toolset to manage it properly.

One particularly difficult task to address is the evolution of business processes. Due to evolution of the context, such as legislation, regulations or customer demand, or internal reorganizations, it is often desirable or necessary to have business processes evolve, add or remove activities, resource usage and decisions. Revising a process and proposing an updated version can be difficult.

Even more difficult to address is the issue, once a process has been revised, of implementing it and making it replace the former version seamlessly. Indeed, a business process instance (i.e. an occurrence of the process being exercised) can span a long time and involve various resources. Switching instantaneously is not possible without considering the impact on those resources and on-going activities. Process instances can be running during migration, and newly added or removed process logic may create inconsistencies in the currently running instances. The notion of a wavefront may be used to differentiate between past states, present states, and future states of a business process instance.

It is a problem to ensure consistency when migrating of running processes instances from an old version of a business process to a new version.

Known solutions propose fully automated techniques to automate process instance migration in a subset of circumstances where the effects of the change between the former and the new version of the process definition can be proven not to invalidate the instance being migrated.

Fully automatic migration is desirable but not always possible. This may be the case when the wavefront of the process instance has passed the process changes, and no automatic decision should be taken without more semantic information.

Fully automatic migration may also not be possible when the changes intersect with the wavefront. For example, an activity has started, but has changed, or an activity has started, and was removed from the new process version (zombies).

For such scenarios, generally applicable, automated migration approaches are difficult to provide.

Therefore, there is a need in the art to address the aforementioned problems.

### BRIEF SUMMARY

Aspects of the present invention provide a method, a system, and a computer program product for process instance migration from a former process model to a new process model. A former process model and a new process model and their data models are analyzed to extract a process delta object model relating to changes in the new process model on which to define migration rules. One or more existing process instances and retaining process instances whose current state has passed the changes in the new process model are analyzed. Candidate activities of the retained process instances are generated. A set of conditions for the candidate activities is generated, and a set of actions to be taken if a condition is met are generated.

The process delta object model may combine a data delta model corresponding to the combination of data that the initial and latter process data models include and how they differ and an activity delta model corresponding to the combination of activities that the initial and latter activity models include and how they differ.

Generating candidate activities may include reading the data state and activity state of a process instance, comparing the data state and activity state with the process delta object model, and selecting a candidate activity when the data state and activity state interest the process delta object model.

Generating a set of conditions for the candidate activities may include leveraging the process delta object model for all candidate activities to synthesize a set of conditions that describe the states of the specific instances.

Generating a set of actions for the candidate activities may include leveraging the process delta object model for all candidate activities to synthesize a set of actions to be taken.

Aspects may include presenting the generated set of conditions and set of actions to a user, enabling the user to combine conditions and actions to produce a process instance migration program in the form of a set of rules.

Analyzing one or more existing process instances may include retaining process instances whose wavefront has passed the changes in the new process model, wherein a wavefront distinguishes between past states, present states, and future states of a process instance.

Generating a set of conditions may include, if a candidate activity is after or on a modified activity in the new process model, creating a condition specifying this step. If there is more than one process instance at this step, aspects may include generating a discriminating condition between each of those process instances.

Generating a set of actions to be taken if a condition is met may include one or more of resetting or cancelling the process instance, passing the process instance step through a modified activity, returning the process instance step to a former activity, moving the process instance to different activity, and performing a manual entry to resolve the ambiguity.

Analyzing a former process model and a new process model and their data models to extract a process delta object model may include restricting the analysis to modified parts of the new process model.

Analyzing a former process model and a new process model and their data models to extract a process delta object model may further include restricting the analysis to activities of the former process model that can be stopped.

Aspects may include refining the set of rules to edit and contextualize the rules based on the specific properties of each instance. Aspects may include executing a process instance migration to evaluate its result, and iterating to generate more rules to cover additional instances. Aspects may also include executing the set of rules on an existing instance to validate the actual outcome and to assess the status of the remaining instances. Multiple related processes may be considered together.

The described aspects of the invention provide the advantage of leveraging rule-based technologies to ease the evolution of business processes. This has the advantage of providing a method that is semi-automated, that allows for taking decisions in specific cases, thus allowing the user to customize how process instance migration is to be performed.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Preferred embodiments of the present invention will now be described, by way of example only, with reference to the following drawings in which:

FIG. 1 is a flow diagram of an example embodiment of a method in accordance with the present invention;

FIG. 2 is a schematic diagram of the components of a method in accordance with the present invention;

FIG. 3 is block diagram of an example embodiment of a system in accordance with the present invention; and

FIG. 4 is a block diagram of an embodiment of a computer system in which the present invention may be implemented.

### DETAILED DESCRIPTION

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Method and system are provided in the form of a tool for guiding users to define their own rules to deal with running process instances in specific cases. This tool proposes contextualized rule conditions and actions that address the existing instances that require a specific decision, and production bodies that perform common decisions that can be made (such as reset a process instance, jump to a specific state, etc.).

The concept of a wavefront of a process instance is used to differentiate between past states, present states, and future states of a business process instance.

The described method may use a wavefront and matches it with the changes between two versions of the process model to define the necessary building blocks to express rules that a user would have to define in order to migrate the state of instances in version 1 to instances now valid in version 2.

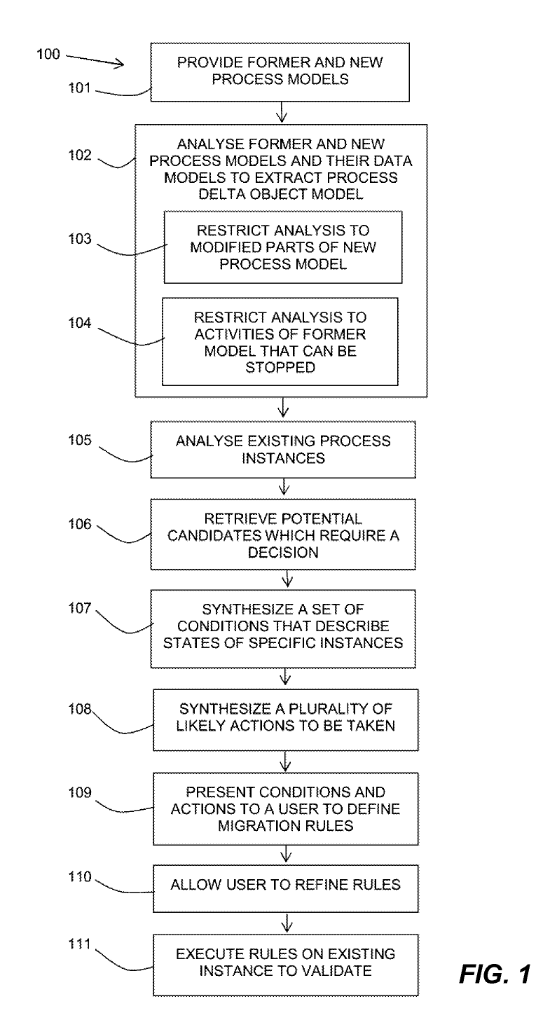

Referring to FIG. 1, a flow diagram shows an example embodiment of the described method.

Former and new process models may be provided 101. Analysis may be carried out 102 of the former and new process models and their data models to extract a process delta object model on which to define rules. The process delta object model combines a data delta model (corresponding to the combination of data that the initial and latter process data models include and how they differ) and an activity delta model (corresponding to the combination of activities that the initial and latter activity models include and how they differ).

The analysis may particularly look at the process activities, and the (former and new) process data definitions to extract the process delta object model from those objects to allow the expression of conditions and actions involving the modified parts of the process.

The analysis may be restricted 103 to those modified parts so as not to overwhelm the user/process manager with alternatives.

The analysis of the former process model may also be restricted 104 to activities in which process instances can be stopped, including notably human activities, asynchronous services, and activities that can be stopped because of a runtime error.

Existing process instances may be analyzed 105 to retrieve 106 potential candidate activities that will require some decision to be taken. This may include retaining existing process instances whose wavefront has passed the changes performed on the process models. For example, their wavefront intersects some modified states.

The analysis 105 may consist of reading the state (data state and activity state) of a process instance, and comparing this state with the process delta object model. When they intersect, the instance may be marked as a positive match. There are at least two intersection patterns:

when the wavefront of this instance contains activities that are also referenced in the process delta object model, directly or as ancestors of activities that have changed;

when the data of the instance include elements whose definitions have changed and this change surfaces in the process delta object model.

All the instances that are marked are instances for which migration is required.

The process delta object model is leveraged at steps 107 and 108 for all candidate activities of retained process instances to synthesize 107 a set of conditions that describe the states of those specific instances and to synthesize 108 a plurality of likely actions to be taken.

A zombie activity is an activity in which a process instance is currently stopped, but which does not exist anymore in the new version of the process definition. Applying this new version to this instance without proper rearrangement would result in having the migrated instance be in an undefined state, stalled forever.

If a process instance (or multiple instances) is analyzed that is stopped in a zombie activity (that existed in a former process definition but that has disappeared in the new process definition), a condition is synthesized to match with this particular instance, and actions to enable choices to put this instance on track in the new process definition. Actions may include, for example, jumps from the zombie activity back to the predecessor activity, or to successor activities, or back to the initial activity, or launch an exception sub process, etc.

If the activity is after or in a modified activity in the process delta object model, a condition may be created specifying this step [the process instance is {location predicate} activity . . . ]. If more than one process instance is at this step, a discriminating condition may be generated between each of those process instances. An example condition is, “if the process instance stopped at activity X, and the value of data property Y equals yy”.

If a process instance (or multiple instances) is analyzed that is stopped before activities that now use a piece of data that was not existing in the former data model, then a condition needs to be generated to match with this instance, and actions to provide a value for this non-initialized piece of data, to move to an activity whose role is to compute or fetch this piece of data, etc.

For all candidate activities of retained process instances, a plurality of likely actions to be taken may be synthesized 108, such as:

Resetting or cancelling the process instance;

Passing the process instance step through a modified activity;

Returning the process instance step to a former activity;

Moving the process instance to different activity;

Performing a manual entry to resolve the ambiguity.

The conditions and actions may be presented 109 to a user in order to define migration rules by enabling the user to bind together conditions and actions to define the migration rules.

Allow the user to further refine 110 and contextualize the rules, for example, based on specific properties/process data of each instance. This may be carried out, for example, using tooling such as the IBM Process Designer complemented by the Rules editor of IBM Operational Decision Manager (ODM) (IBM is a trade mark of International Business Corporation).

Finally, the produced ruleset may be executed 111 on the existing instance basis before committing to allow for:

Validating the actual outcome; and

Assessing the status of the remaining instances (instances for which nothing has been done).

Validating the actual outcome validates that the final state of migrated instances meet the user expectations. After migration, each instance has a new wavefront and a new data state. Users may browse these and confirm that this new state is valid with regards to the business intentions that they had initially when they defined the new process definition.

When assessing the status of the instances that have not been touched by the migration rules, the user may decide to:

refine existing rules or add rules to the rule base to reach the instances that were not touched (this assessment/refinement activity may an interactive and iterative process); or

manage remaining instances individually, manually. This may include: deleting the instance, resetting the instance, or leaving the instance as-is. If the instance is left as-is, it may resume its execution and let it reach an error or exception condition (which might be intercepted by an exception handling activity in the same process or in collaborating process, such as a manual processing by an operator).

The execution of the ruleset may be carried out by the same tool that allowed the rules to be defined and refined (for example, in conjunction with the IBM ODM rule engine).

The described method includes steps to extract necessary building blocks to enable the user with the right level of classification of the running instances. For instance, the method would realize that some instances stopped at A are either also stopped at B or at C, and would create reusable condition expressions for the user to be able to differentiate between those two subsets of instances, and have different rules to cover those subsets adequately.

### EXAMPLE

For instance, in a case where a process involves a legal clearance activity, and this activity has to be refined to comply with new corporate regulations, the following rule would need to be created:

“if

the running process instance stopped at activity ‘legal clearance’

and the legal compliance of the contract is ‘IP At Risk’

then

move the new process instance to activity ‘Evaluate IP Compliance’;

set the legal compliance of the contract to ‘IP under Evaluation’;”

The user may add as many rules as required to cover all running instances. Due to the first analysis, the vocabulary provided to the user to express migration rules is limited to those parts that actually need to be handled.

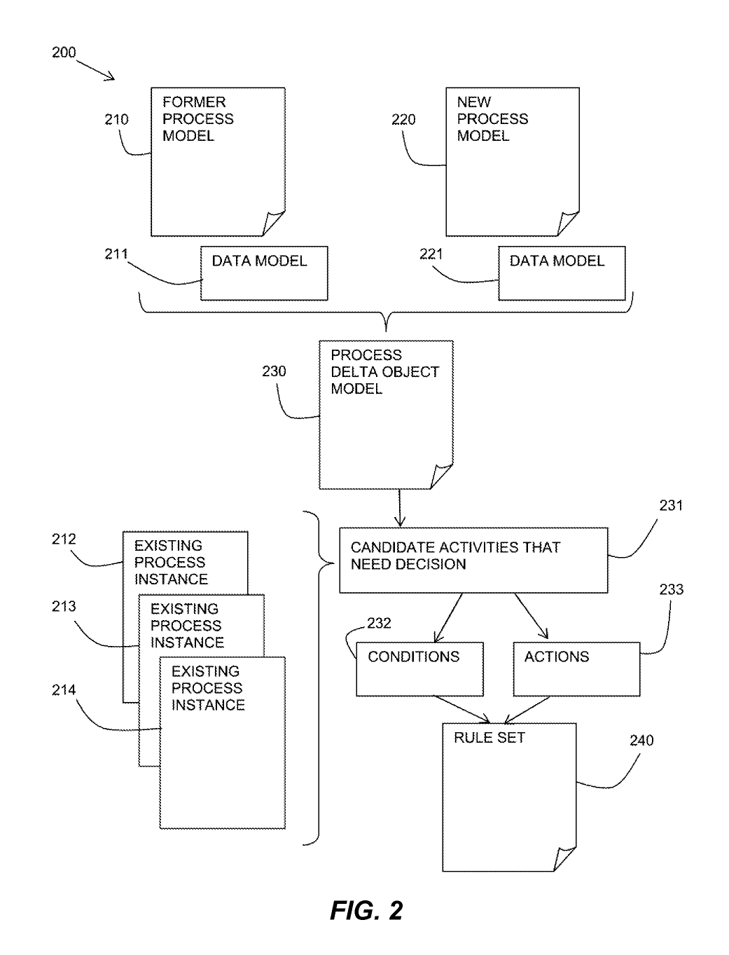

Referring to FIG. 2, a schematic diagram 200 shows the components used and generated by the described method.

A former process model 210 and a new process model 220 are accessed for analysis including their data models 211, 221. The analysis generates a process delta object model 230 expressing conditions and actions involving modified parts of the process between the former process model 210 and the new process model 220.

Existing process instances 212-214 may be accessed and analyzed to retrieve candidate activities 231 that require a decision. From the candidate activities 231, conditions 232 and actions 233 may be generated. These may be combined in a rule set 240 of rules for migrating from a former process to a new process.

The described system comprises two parts:

An analysis part formed of the analysis modules that generate rule fragments for the user to assemble into a process instance migration set of rules; and

A rules part providing an environment to assemble and edit the selected fragments into a migration prescription and exercise it.

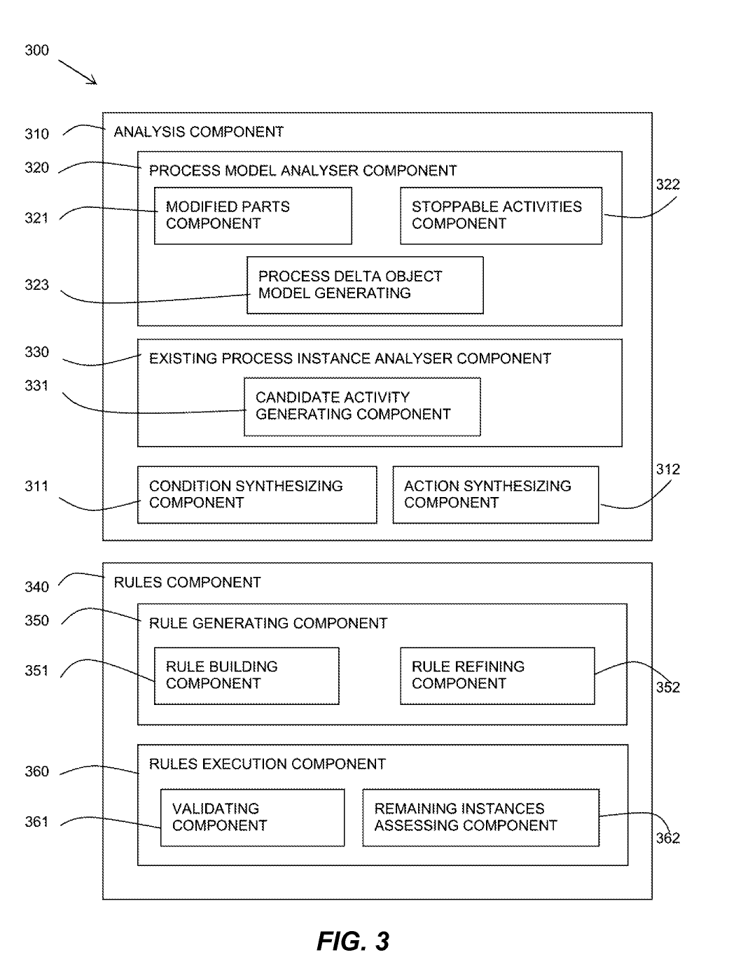

Referring to FIG. 3, a block diagram 300 shows an example embodiment of the described system.

An analysis component 310 may be provided for carrying out the analysis part. A process model analyzer component 320 may be provided for receiving a former process model and a new process model and analyzing the models and their data models. The process model analyzer component 320 may include a modified parts component 321 for restricting the analysis to modified parts of the new process model, and a stoppable activities component 322 for restricting the analysis to activities in the former process model which may be stopped. The process model analyzer component 320 may also include a process delta object model generating component 323 for generating a process delta object model from the analysis.

The analysis component 310 may also include an existing process instance analyzer component 330 which leverages the process delta object model for analyzing existing process instances and may include a candidate activity generating component 331 for retrieving potential candidate activities from the instances that require a decision to be taken.

The analysis component 310 may also include a condition synthesizing component 311 which leverages the process delta object model for generating a set of conditions that described the states of the retained process instances for candidate activities.

The analysis component 310 may also include an action synthesizing component 312 which leverages the process delta object model for generating a set of actions to be taken for the conditions.

A rules component 340 may be provided for carrying out the rules part. The rules component 340 may include a rule generating component 350 enabling a user to generate rules using the synthesized conditions and actions. The rule generating component 350 may include a rule building component 351 and a rule refining component 352.

The rules component 340 may also include a rules execution component 360 for executing the rules which may include a validating component 361 for validating the outcome and a remaining instances assessing component 362 for assessing the status of remaining instances.

The described method applies to the context of a business process management (BPM) software suites with leveraged rules to implement the process migration.

As part of such suites, a variety of tools enable the definition of business processes using a common notation, such as business process model and notation (BPMN). The described system may assume those products provide a suitable application programming interface and means to retrieve a process definition and analyze it.

In addition, the described system may involve the usage of a business rule management system (BRMS) system to provide the base vocabulary, rule definition, and rule execution environment.

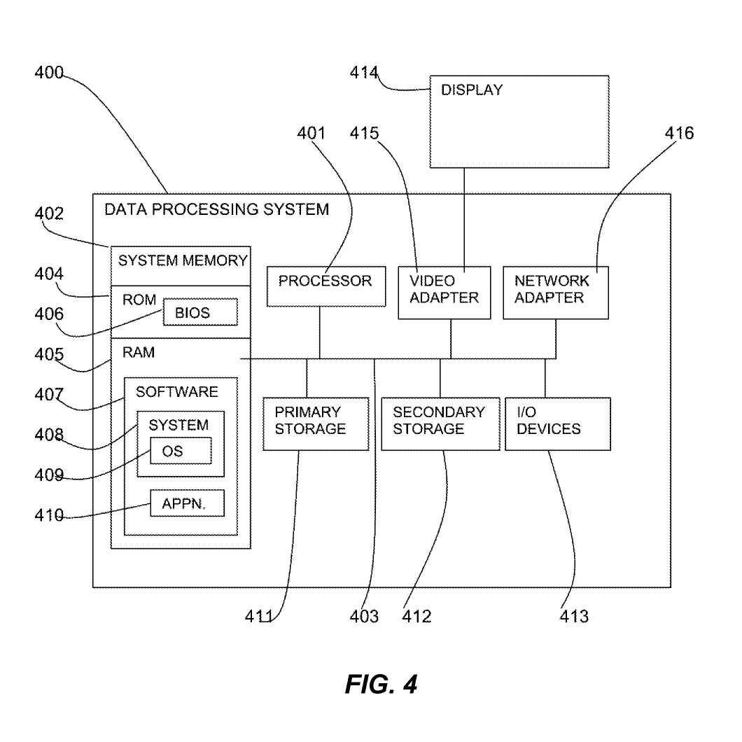

Referring to FIG. 4, an exemplary system for implementing aspects of the invention includes a data processing system 400 suitable for storing and/or executing program code including at least one processor 401 coupled directly or indirectly to memory elements through a bus system 403. The memory elements may include local memory employed during actual execution of the program code, bulk storage, and cache memories which provide temporary storage of at least some program code in order to reduce the number of times code must be retrieved from bulk storage during execution.

The memory elements may include system memory 402 in the form of read only memory (ROM) 404 and random access memory (RAM) 405. A basic input/output system (BIOS) 406 may be stored in ROM 404. System software 407 may be stored in RAM 405 including operating system software 408. Software applications 410 may also be stored in RAM 405.

The system 400 may also include a primary storage means 411 such as a magnetic hard disk drive and secondary storage means 412 such as a magnetic disc drive and an optical disc drive. The drives and their associated computer-readable media provide non-volatile storage of computer-executable instructions, data structures, program modules and other data for the system 400. Software applications may be stored on the primary and secondary storage means 411, 412 as well as the system memory 402.

The computing system 400 may operate in a networked environment using logical connections to one or more remote computers via a network adapter 416.

Input/output devices 413 may be coupled to the system either directly or through intervening I/O controllers. A user may enter commands and information into the system 400 through input devices such as a keyboard, pointing device, or other input devices (for example, microphone, joy stick, game pad, satellite dish, scanner, or the like). Output devices may include speakers, printers, etc. A display device 414 is also connected to system bus 403 via an interface, such as video adapter 415.

Further details are provided below of the aspects of the described method.

1. Process model analysis
For all process items (for example, activities, decisions, etc.) in the old and new model. Optional filter condition: If the item is connected to an item that is different in the old and new models then . . .

If the current item's class that has not already been described in the process delta object model:
Define a class describing the process delta object model describing the current item class.
   2. Process instance analysis
   For all running process instances:
   If the wavefront of the process intersects a process item that is different between the new and the old model:
Add the process instance to the list of instances to create a condition for.
   3. Condition generation for running process instances
   For all collected process instances:

For all activities of this process instance {
Generate a condition matching this particular activity
(for example, the process instance stopped at activity X . . . )
   }

If a similar condition has already been added, generate a condition allowing discriminating each individual process instances occurring at this particular activity (for example, examine the process instances, make diff of their state, and produce that diff as possible conditions to express rules).

From all the generated conditions, distinguish the conditions that match an activity that has changed between the old and the new process model: those are the necessary rules to create in order to allow process instance migration.

For each distinguished condition, associate the particular discriminating conditions that have been associated to this activity.

For all activities of the wavefront, if the element is after or on a changed step, then a rule is fired. In consequence, the end result of this analysis method is a tree of conditions usable to form migration rules:

necessary conditions;
likely associated conditions;
that the user/process manager will use to define their migration procedure.
4. Migration statements generation for running instances
From the difference between old and new process diagrams, list likely actions to be taken:
“Reset process instance”;
“Move process instance from activity X to new activity Y” for all Y which denote an added activity and X which denote an activity immediately before or after Y;
“Move process instance from activity X to activity Y” for all X which denote a removed activity, where Y denotes an activity immediately before or after where X was;
“Return to task X” for all X which denote an activity before an added or removed activity in the new instance;
“Cancel process instance”.
5. Process instance migration program creation
Provide the user with a means to bind together conditions and actions to define the migration rules.

Allow the user to further edit and contextualize those rules based, for instance, on specific properties of each instance (for example, with using a rule management system to maintain logic).

Finally, the same tool shall provide a means to execute the produced ruleset on existing instances before committing to:

Validate the actual outcome;
Measure the remainder instances for which nothing has been done.

It may be possible to simulate the execution of the ruleset before actually applying the migration to verify coverage.

There may also be an interactive scenario where the user will apply rules, realize that some instances have not been migrated, author some more rules to cover more instances, rerun, etc. until completion.

Multiple related processes (by direct invocation or by asynchronous messaging) may be considered altogether in the definition of the wavefront, and in the scoping of correlated process instances.

The migration actions may include the application of a supplied “undo” process, when the wavefront has already passed steps of the former process definition, which have produced some side effects that have to be “compensated”.

The described method may be further generalized to the needs of fixing instances that are in an inconsistent/incomplete state (regardless of a process change), or instances to be fixed because of a decision to globally change the state of a set of instances.

The described method covers changes at the activity flow level of the process model and at the data model level of the process model with state model (or wavefront model) and data model transformation building blocks and rules.

By providing building blocks for a user to author migration rules at the data model and at the wavefront model, migration of process instances related to a process model change, that would include one or more of these cases would be possible, and thus, those limitations can be at least partially, if not totally, overcome.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Improvements and modifications can be made to the foregoing without departing from the scope of the present invention.

1. A computer implemented method for process instance migration from a former process model to a new process model, comprising:
analyzing, by a computer, a former process model and a new process model and their data models and extracting a process delta object model relating to changes in the new process model on which to define migration rules;
analyzing, by the computer, one or more existing process instances and retaining process instances whose current state has passed the changes in the new process model;
generating, by the computer, candidate activities of the retained process instances;
generating, by the computer, a set of conditions for the candidate activities; and
generating, by the computer, a set of actions to be taken if a condition is met.

2. The method as claimed in claim 1, wherein extracting the process delta object model comprises combining a data delta model corresponding to the combination of data that the initial and latter process data models include and how they differ, and an activity delta model corresponding to the combination of activities that the initial and latter activity models include and how they differ.

3. The method as claimed in claim 1, wherein generating candidate activities includes:
reading the data state and activity state of a process instance;
comparing the data state and activity state with the process delta object model; and
selecting a candidate activity when the data state and activity state interest the process delta object model.

4. The method as claimed in claim 1, wherein generating a set of conditions for the candidate activities includes:
leveraging the process delta object model for all candidate activities to synthesize a set of conditions that describe the states of the specific instances.

5. The method as claimed in claim 1, wherein generating a set of actions for the candidate activities includes:
leveraging the process delta object model for all candidate activities to synthesize a set of actions to be taken.

6. The method as claimed in claim 1, further comprising:
presenting the generated set of conditions and set of actions to a user enabling the user to combine conditions and actions to produce a process instance migration program in the form of a set of rules.

7. The method as claimed in claim 1, wherein analyzing one or more existing process instances includes retaining process instances whose wavefront has passed the changes in the new process model, wherein a wavefront distinguishes between past states, present states, and future states of a process instance.

8. The method as claimed in claim 1, wherein generating a set of conditions includes:
if a candidate activity is after or in a modified activity in the new process model, creating a condition specifying the modified activity.

9. The method as claimed in claim 8, further comprising:
if there is more than one retained process instance, generating a discriminating condition between each of more than one retained process instances.

10. The method as claimed in claim 1, wherein generating a set of actions to be taken if a condition is met includes one or more of the group of: resetting or cancelling the process instance; passing the process instance step through a modified activity; returning the process instance step to a former activity; moving the process instance to different activity; performing a manual entry to resolve the ambiguity.

11. The method as claimed in claim 1, wherein analyzing a former process model and a new process model and their data models to extract a process delta object model includes:
restricting the analysis to modified parts of the new process model.

12. The method as claimed in claim 1, wherein analyzing a former process model and a new process model and their data models to extract a process delta object model includes:
restricting the analysis to activities of the former process model that can be stopped.

13. The method as claimed in claim 6, further comprising:
refining the set of rules to edit and contextualize the rules based on the specific properties of each instance.

14. The method as claimed in claim 6, further comprising:
executing a process instance migration to evaluate its result, and iterating to generate additional rules to cover additional instances.

15. The method as claimed in claim 6, further comprising:
executing the set of rules on an existing instance to validate the actual outcome and to assess the status of the remaining instances.

16. The method as claimed in claim 1, wherein multiple related processes are considered together.

17-25. (canceled)

26. A computer system for process instance migration from a former process model to a new process model, the computer system comprising:
one or more computer processors, one or more computer-readable storage media, and program instructions stored on one or more of the computer-readable storage media for execution by at least one of the one or more processors, the program instructions comprising:
program instructions to analyze a former process model and a new process model and their data models and extract a process delta object model relating to changes in the new process model on which to define migration rules;
program instructions to analyze one or more existing process instances and retaining process instances whose current state has passed the changes in the new process model;
program instructions to generate candidate activities of the retained process instances;
program instructions to generate a set of conditions for the candidate activities; and
program instructions to generate a set of actions to be taken if a condition is met.

27. The system as claimed in claim 26, further comprising:
program instructions to present the generated set of conditions and set of actions to a user enabling the user to combine conditions and actions to produce a process instance migration program in the form of a set of rules.

28. The system as claimed in claim 26, wherein the program instructions to analyze a former process model and a new process model includes a modified parts component for restricting the analysis to modified parts of the new process model.

29. The system as claimed in any one of claim 26, wherein the program instructions to analyze a former process model and a new process model includes:
program instructions to restrict the analysis to activities of the former process model that can be stopped.
